(19) United States
(12) Patent Application Publication
(10) Pub. No.: US 2013/0207397 A1
(43) Pub. Date: Aug. 15, 2013

(54) TETHER FOR RENEWABLE ENERGY SYSTEMS

(71) Applicants: Rigobert Bosman, Landgraaf (NL); Christiaan Henri Peter Dirks, Dilsen (BE); Roelof Marissen, Born (NL); Johannes Petrus Marinus Plug, Stevensweert (NL); Paulus Johannes Hyacinthus Marie Smeets, Geulle (NL)

(72) Inventors: Rigobert Bosman, Landgraaf (NL); Christiaan Henri Peter Dirks, Dilsen (BE); Roelof Marissen, Born (NL); Johannes Petrus Marinus Plug, Stevensweert (NL); Paulus Johannes Hyacinthus Marie Smeets, Geulle (NL)

(73) Assignee: DSM IP ASSETS B.V., Heerlen (NL)

(21) Appl. No.: 13/811,768

(22) PCT Filed: Jul. 26, 2011
(86) PCT No.: PCT/EP11/62804

§ 371 Date: Apr. 11, 2013

(30) Foreign Application Priority Data
Jul. 26, 2010 (EP) 10170805.5

(51) Int. Cl. H01B 7/16

(52) U.S. Cl. CPC H01B 7/16
USPC 290/53; 174/124 R

(57) ABSTRACT

The present invention provides a tether (1) containing strands (2) comprising high strength fibers and a plurality of conductors (4), wherein each conductor (4) is separated from any other conductor along its length by at least one of said strands. The tether (1) can be used for transporting electrical power from a high altitude wind energy generator or a wave and tidal energy generator to a ground station.

The present invention relates to a tether, as for example those suitable for utilization in renewable energy systems, the tether containing strands comprising high strength fibers and a plurality of conductors. The invention further relates to the use of such a tether for anchoring and/or providing an electrical current or a signal to or from a system, preferably a renewable energy system.

In view of the limited resources of fossil fuels in the world and the need to reduce CO₂ emission, there is an increased demand for alternative sources of energy, in particular for energy from a renewable source. Different renewable energy systems are currently being developed using, among others, wind energy, solar energy or wave and/or tidal energy as a source.

Wave energy systems use the energy in the movements of water near the surface of the sea, which may result from wind streams due to solar heat. Examples of wave energy systems are power buoys, where a floating buoy is moored to the sea bed and attenuator systems, which is a floating hinged system with moving segments.

Tidal energy systems use the energy resulting from the rise and fall of tides, which may be due to gravitational forces of the moon (and sun). Examples of tidal wave energy systems are submerged turbines, mounted on existing wind turbine systems and rigid panels moving with tidal streams.

An example of a wind energy system is a high altitude wind energy system, which generally consists of a kite, balloon or airplane like structure that flies at an altitude of from 100 to 11.000 m, or from 100 to 2000 m, making optimal use of the high altitude winds. Different systems currently exist, which include systems with a ground-based generator, but also systems with an air-borne, or flying generator have been suggested. An example of such a system is described in U.S. Pat. No. 7,335,000.

The majority of the systems as described above will need a tether to anchor the system to an anchoring point, e.g. to the ground or to the sea bed. The systems may also need one or more cables to either transport power to the system for controlling the system, or to transport power from a generator to a ground station.

A tether for a high altitude wind systems is for instance know from WO09142762. This document describes a tether having a cross-section designed for less aerodynamic drag.

Another tether suitable for use in communication, remote control and/or as a guide cable is also known from EP 0 287 517 and U.S. Pat. No. 4,861,947. It contains a plurality of conductors and a reinforcing member comprising super strong plastic filaments such as for example Kevlar and Arenka or inorganic fibers such as carbon fibers.

Further descriptions of tethers may be found in WO2004/008465 and U.S. Pat. No. 4,819,914.

A drawback of the known tethers and in particular the high power tethers is that they contain conductors heavily insulated, which in turn makes the tether heavy and difficult to install and maintain.

A further drawback of known tethers is that they are less suitable to include or carry cables needed to transport power generated by, for instance, an air-borne generator. The power generated by such a system can typically be from 10 kW to 2 MW and electrical cables having a thickness of at least 10 mm may be necessary. Furthermore high altitude wind energy system by its movement can generate forces of as high as 1000 kN, or even up to 5000 kN.

A yet further drawback of the known tethers is that their capacity of transporting a signal fails when said tether is subjected to a relatively low mechanical load, e.g. tension. It was observed that in some instances the failure of the tether occurs almost immediately after the tether is deformed and it often occurs at the points where the tether is connected to the anchoring point or to the renewable energy system.

Thus, a tether for such a system has to withstand high forces and at the same time be able to transmit signals, e.g. transport power. Moreover, the tether should be lightweight because heavy cables would compromise too much the movement of the e.g. renewable energy system.

In an attempt to overcome the above mentioned drawbacks, the invention provides a tether containing strands comprising high strength fibers and a plurality of conductors, wherein each conductor is separated from any other conductor along its length by at least one of said strands.

In a preferred embodiment, the tether of the invention has a length direction and wherein the conductors contained by said tether have an area as measured from a cross section perpendicular to said length direction of the tether of from 15% to 75% of the total area of said cross section.

In a further embodiment, the invention provides a tether containing strands comprising high strength fibers and at least one conductor, wherein the tether has a length direction and wherein the at least one conductor contained by said tether has an area as measured from a cross section perpendicular to said length direction of the tether of from 15% to 75% of the total area of said cross section.

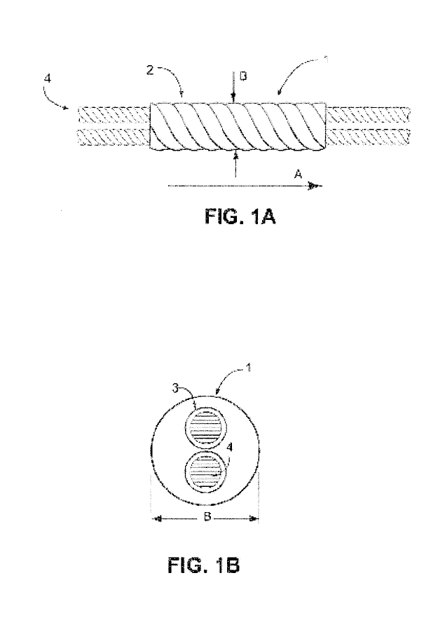

In a further preferred embodiment and with reference to FIG. 1, the invention relates to a tether (1) having a length direction (A), wherein the tether comprises strands (2), preferably primary strands, comprising high strength fibers and at least one conductor (4), wherein the tether has a construction such that it comprises one or more longitudinal voids (3) suitable for receiving the conductor (4), and the area of the at least one conductor in a cross section (B) perpendicular to the length direction (A) of the tether is 15% to 75% of the total area of said cross section (B).

The advantage of the invention is that the tether may show an optimum balance between strength and conductivity. In particular it was observed that high power tethers, e.g. Mega Watts (MW) and even hundreds MW power tethers, of the invention may also show a sufficient strength to enable the manufacturing of tethers having sufficient lengths to be suitable for use in high altitude or large depths systems, e.g. renewable energy systems.

A further advantage of the tether of the invention may be that the insulations of the conductors may be reduced, reducing therefore the weight thereof, yet preserving the safety of the tethers.

It was also observed that the tether has sufficient strength to withstand the forces exerted on it. Due to this construction the conductors contained for example in the voids of the tether are protected and are less likely to break under load or form a short circuit when the original insulation, e.g. the jacket, on the conductors gets damaged.

A further advantage of the tether of the invention is that its signal transporting capacity diminishes less than that of the known tethers when it is deformed.

With tether according to the invention is meant a rope or line to be attached to a system which preferably produces energy, e.g. a renewable energy system, to anchor said system and/or to guide or transport power to and/or from the system, in particular the renewable energy system, to a ground station.

According to an embodiment of the invention, each conductor is separated from any other conductor along its length, preferably its entire length, by at least one of the strands. By separated is herein understood that at least one strand is interposed between said conductors along their length such that the conductors are at a distance sufficient enough to prevent unwanted interferences. For example when conductors are used to transport power, the distance between said conductors should be sufficient to prevent the occurance of a short circuit.

With “longitudinal voids” is meant that the conductors which are included in the voids and which substantially fill the voids, run in the length direction of the tether. Depending on the particular embodiment of the tether construction, the conductors can be wound spirally around a central longitudinal core, or can be straight, parallel to the length direction.

With “conductor” according to the invention is meant a material able to conduct a signal such as an electrical or optical signal and preferably able to conduct power (electricity) from a generator where the power is generated, to a point where signal needs to be transported or the electricity can be collected. By “conducting a signal” may be understood within the spirit of the invention also as “transporting a signal”. A conductor may also contain a single or a plurality of cables suitable for the intended purpose of conducting or transporting a signal, wherein said cables may contain or be free of an insulation jacket. Preferably, the conductors are suitable to transport electricity and are suitable to withstand an electrical power of at least 0.1 MW, more preferably at least 10 MW, more preferably at least 100 MW. It was observed that the tether of the invention is optimum for transporting such high amounts of electricity, and in particular the most optimal balance strength/power may be obtained when such high power conductors are used. Preferably, the conductors used in the tether of the invention are suitable for carrying voltages of between 1000 V and 100.000 V.

As described above, the tether of the invention contains strands, which may be primary strands. It is generally known in the rope manufacturing industry to make a rope structure where yarns containing fibers or filaments (see below) are twisted into larger rope yarns and then the rope yarns are used to form a strand. The strand can be made by laying or braiding the rope yarn or can contain parallel yarns. Preferably, the strands of the tether of the invention carry at least part of the load generated in said tether by the system utilizing it. The tether of the invention may however also contain strands that do not carry a load but are used for other purposes, e.g. improve various properties of the tether such as abrasion, torsion and the like. Preferably, the at least one strand that separates the conductors contained by the tether of the invention also carry at least part of said load.

In the present invention with primary strands is meant those strands that are the first strands that are encountered when the rope is opened up. In general these are the outermost strands of the rope, but may also include a core strand, if present. The primary strands may be made up of further secondary strands.

The strands, e.g. the primary strands, of the tether of the invention contain yarns that comprise high strength fibers. By fiber is herein understood an elongate body, the length dimension of which is much greater that the transverse dimensions of width and thickness. Accordingly, the term fiber includes filament, ribbon, strip, band, tape, and the like having regular or irregular cross-sections. The fibers may have continuous lengths, known in the art as filaments, or discontinuous lengths, known in the art as staple fibers. Staple fibers are commonly obtained by cutting or stretch-breaking filaments. A yarn for the purpose of the invention is an elongated body containing many fibers.

With high strength fibers for use in the tether of the invention fibers are meant having a tenacity of at least 1.5, more preferably at least 2.0, 2.5 or even at least 3.0 N/tex. Tensile strength, also simply strength, or tenacity of filaments are determined by known methods, as based on ASTM D2256-97. Generally such high-strength polymeric filaments also have a high tensile modulus, e.g. at least 50 N/tex, preferably at least 75, 100 or even at least 125 N/tex.

It is known to include conductors in tethers or ropes of high strength fibers. However, in existing tethers or ropes, all conductors are either joined together or crossing each other and thus forming a thicker conductor, either distributed in touching proximity on the surface of the load carrying element of the tether or the rope. In particular, the area of the conductor in the total cross-section of the tether or the rope is either relatively low, e.g. less than 5%, as for example is the case of the inclusion of an electrical steering cable, either relatively high. Applications where low areas of the conductors are used only require and are suitable for relatively low power currents. As already mentioned, tethers or ropes exist where single thicker conductors are used, wherein their cross-section is relatively high, e.g. more than 90%, in which case the high strength fibers are only used to provide an insulation jacket to the conductor and do not contribute to the strength of the tether or the rope, i.e. do not contribute in carrying the load applied on the tether or the rope.

The present invention thus preferably provides a tether as described above, wherein the area of the one or more conductors in the cross section of the tether is at least 15%, more preferably at least 20%, even more preferably at least 30% of the total area of the cross section of the tether.

The area of the one or more conductors in the cross section of the tether is at the most 80%, preferably at the most 60%, more preferably at most 40% of the total area of the cross section as this allows for optimal balance of electrical conductivity and strength.

Typically, a conductor has an active area and an insulation area, wherein the active area is the area on a cross-section of the conductor through which the signal may be transported or carried, and wherein the insulation area is the area through which the signal cannot be carried or transported. The insulation area typically surrounds the active area and in some instances it may be missing. The area of the one or more conductors as defined in accordance with the invention preferably includes both the insulation and the active areas; more preferably only includes the active areas of the one or more conductors.

The tether of the invention preferably has a diameter of at least 20 mm, more preferably at least 40 mm. The maximum diameter for the tether where it can maintain its beneficial properties is 500 mm, preferably 300 mm. Most preferred is a tether with a diameter of 40 to 80 mm.

In order to be suitable for renewable energy systems, the tether of the invention preferably has a length of at least 50 m, preferably at least 100 m, more preferably at least 200 m, but lengths up to 5000 m can also be envisaged. Preferably the tether has a length of 100 m to 1000 m.

Tethers with such lengths may be obtained using splicing techniques, for instance using a splice to connect different ends of rope or by connecting different ends of rope together. An example of a splice is described in WO2004/039715. It was observed that while known tethers having a length of more than 50 m usually loose their signal transporting capacity at the splice at relatively low loads applied on the tether, the tether of the invention even when of great length may show improved signal transporting properties even under large mechanical loads. Also the signal transporting properties of the known tethers between splices may be reduced as compared to the tether of the invention.

Preferably, the tether of the invention contains one conductor, more preferably at least two conductors. The number of conductors is dependant on the application for which the tether of the invention is intended. Preferably, each conductor is separated from any other conductor by strands. Preferably, the conductors are braided with the strands, wherein the braid preferably contains a core, wherein the core preferably contains a strand.

Preferably, the tether of the invention comprises at least two longitudinal voids each containing a conductor. More voids can be present, depending on the particular construction chosen.

The conductor is made of a suitable conductive metal. Preferred conductive metals are aluminum and copper. Most preferred is aluminum for high altitude wind energy systems. Because aluminum has less than one third the density of copper, an aluminum conductor of equal current carrying capacity is only half the mass of a copper conductor.

In order to have optimal conductivity and limited brittleness of the metal, especially in high strain applications, preferably a metal of high purity is used, i.e. a metal that does not contain other metals or impurities. Preferably, the conductor is aluminum or copper with a purity of at least 98 wt. % based on the total weight of the conductor, more preferably at least 99 wt. %.

The conductor used may consist of metal wires, that can be twisted or braided. The diameter of the conductor in the tether is preferably at least 4 mm, preferably at least 8 mm, more preferably at least 10 mm. The diameter can be up to 80 mm.

The conductor can be further provided with a jacket, for insulation purposes, or to protect the conductor against abrasion. The materials for making such jackets, e.g. thermoplastic polymers and the methods for producing them, e.g. by extrusion are known to the person skilled in the art.

According to a preferred embodiment of the invention, the conductor is provided with a braided jacket of high strength fibers, preferably high modulus polyethylene fibers, as described hereafter.

An advantage of the tether according to the invention and in particular of the high power tether may be that the resulting tether may be of relatively small diameter as compared to a standard rope and yet having the same maximum load-bearing capacity and being able to transmit high power electricity.

Examples of high strength fibers are (ultra) high molecular weight polyethylene (U)HMWPE fibers, fibers manufactured from polyaramides, e.g. poly(p-phenylene terephthalamide) (known as Kevlar®); poly(tetrafluoroethylene) (PTFE); aromatic copolyamid (co-poly-(paraphenylene/3,4′-oxydiphenylene terephthalamide)) (known as Technora®); poly{2,6-diimidazo-[4,5b-4′,5′e]pyridinylene-1,4(2,5-di hydroxy)phenylene} (known as M5); poly(p-phenylene-2, 6-benzobisoxazole) (PBO) (known as Zylon®); thermotropic liquid crystal polymers (LCP) as known from e.g. U.S. Pat. No. 4,384,016; but also polyolefins other than polyethylene e.g. homopolymers and copolymers of polypropylene. Also combinations of fibers manufactured from the above referred polymers can be used in the tether of the invention. Preferred high-strength fibers however are fibers of HMPE, polyaramides and/or LCP.

A preferred high strength fiber for use in the tether of the invention is (Ultra) high molecular weight polyethylene ((U)HMWPE). Said polyethylene fibers may be manufactured by any technique known in the art, preferably by a melt or a gel spinning process.

If a melt spinning process is used to manufacture the (U)HMWPE fibers, the polyethylene starting material used for manufacturing thereof preferably has a weight-average molecular weight between 20,000 and 600,000, more preferably between 60,000 and 200,000. An example of a melt spinning process is disclosed in EP 1,350,868 incorporated herein by reference.

Best results are obtained if a yarn of gel spun fibers of high or ultra high molecular weight polyolefin is used in the core of the hybrid rope, e.g. those sold by DSM Dyneema under the name Dyneema®.

The gel spinning process is described in for example GB-A-2042414, GB-A-2051667, EP 0205960 A and WO 01/73173 A1. This process essentially comprises the preparation of a solution of a polyolefin of high intrinsic viscosity, spinning the solution to filaments at a temperature above the dissolving temperature, cooling down the filaments below the gelling temperature so that gelling occurs and drawing the filaments before, during or after removal of the solvent.

Preferably, UHMWPE is used with an intrinsic viscosity of at least 3 dl/g, determined in decalin at 135° C., more preferably at least 5 dl/g, most preferably at least 8 dl/g. Preferably the IV is at most 40 dl/g, more preferably at most 25 dl/g, more preferably at most 20 dl/g.

The intrinsic viscosity is determined according to PTC-179 (Hercules Inc. Rev. Apr. 29, 1982) at 135° C., the dissolution time being 16 hours, the anti-oxidant is DPBC, in an amount of 2 g/l solution, and the viscosity is measured at different and is extrapolated to zero concentration.

Preferably, the UHMWPE has less than 1 side chain per 100 C atoms, more preferably less than 1 side chain per 300 C atoms.

Preferably, the UHMWPE fibers have deniers per filament in the range of from 0.1 to 50, more preferably from 0.5 to 5. The UHMWPE yarns preferably are from 200 to 50,000, more preferably from 500 to 10,000, most preferably from 800 to 4800 denier. The tenacity of the polyethylene fibers utilized in the present invention as measured according to ASTM D2256 is preferably at least 1.2 GPa, more preferably at least 2.5 GPa, most preferably at least 3.5 GPa. The tensile modulus of the polyethylene fibers as measured according to ASTM D2256 is preferably at least 30 GPa, more preferably at least 50 GPa, most preferably at least 60 GPa. In order to fully have the advantage of the use of the UHMWPE fibers, it is preferred that the tether contains at least 60 wt %, based of the total weight of the high-strength fibers in the tether, of UHMWPE fibers. More preferably the tether contains at least 70 wt. % of even at least 80 wt. % UHMWPE fibers. The remaining weight of the tether may consist of fibers manufactured from other polymers as enumerated hereinabove.

According to a preferred aspect of the invention, the tether is a braided rope containing at least 5 primary strands and having at least two longitudinal voids. Preferably, the braided rope has 5, 8 or 12 primary strands.

The advantage of this type of construction is that the conductor runs in substantially a straight line, parallel to the length direction of the tether. The strands run across each of the conductors, i.e. up and under the conductor.

While the braided rope with 5 primary strands has two longitudinal voids, a braided rope with 8 primary strands has 4 longitudinal voids and can thus contain 4 conductors.

Methods of making braided ropes with 5, 8 or 12 primary strands are known in the art and conventional braiding machines can be used. The conventional braiding machines also allow for the conductors to be included in the braided rope.

The primary strands can further contain secondary strands, preferably at least 3 secondary strands. The secondary strands can be laid or braided to make up the primary strands.

According to a second aspect of the invention, the tether is a rope having a primary core strand containing high strength fibers, wherein the primary core is surrounded by at least four primary cover strands containing high strength fibers and at least two strands containing a conductor.

The advantage of this construction is that the conductors have the same length as the strands containing high strength fibers surrounding them. Under tension, should the high strength fibers stretch, the conductor can stretch over the same length.

According to this construction, the primary core can be laid or braided from secondary core strands, for instance from 3 to 6 secondary core strands. The primary core can also contain parallel strands or yarns.

A cover, for example a braided or extruded cover may surround the primary core strand, in between the primary core strand and the primary cover strands. Other types of covers are also suitable such as pultruded covers or coated covers. In a preferred embodiment the cover also comprises fibers of ultrahigh molecular weight polyethylene (UHMWPE), preferably braided.

The primary cover strands and the strands containing the conductor are laid, i.e. twisted around the primary core strand. The primary cover strands as described above can form a first layer of primary cover strands. This first layer of primary core strands can be surrounded by a second layer of cover strands.

Techniques of making such rope constructions are known in the art.

According to a preferred embodiment, the strands containing the high strength fibers are pre-stretched before constructing the tether. This pre-stretching step is preferably performed at elevated temperature but below the melting point of the (lowest melting) filaments in the strands (also called heat-stretching or heat-setting); preferably at temperatures in the range 80-150° C. Such a pre-stretching step is described in. EP 398843 B1 or U.S. Pat. No. 5,901,632.

In order to connect the tether to the ground station and to the renewable energy system, end fittings need to be provided. These can be known end fittings such as socket and spike end fittings. In a preferred construction, the conductor will exit the tether at a certain length before the end of the tether. A certain length of tether, not containing the conductor will remain to be incorporated in the end fitting. It is also possible that the conductor exits the rope through the end fitting.

The tether according to the invention can be used for anchoring and/or providing an electrical current to or from a high altitude wind energy system. The tether is most suitable for high altitude wind energy systems which are provided with an airborne generator and wherein the tether transports power from the generator to a ground station.

The tether according to the invention can also be used for anchoring and/or transporting power from a wave and tidal energy system.

The present invention also provides a renewable energy system, comprising a renewable energy generator, a ground station for receiving energy and a tether as described above, wherein the tether connects the renewable energy generator with the ground station.

The invention is further illustrated by means of the drawings, wherein

FIG. 1 shows schematically the tether of the invention;

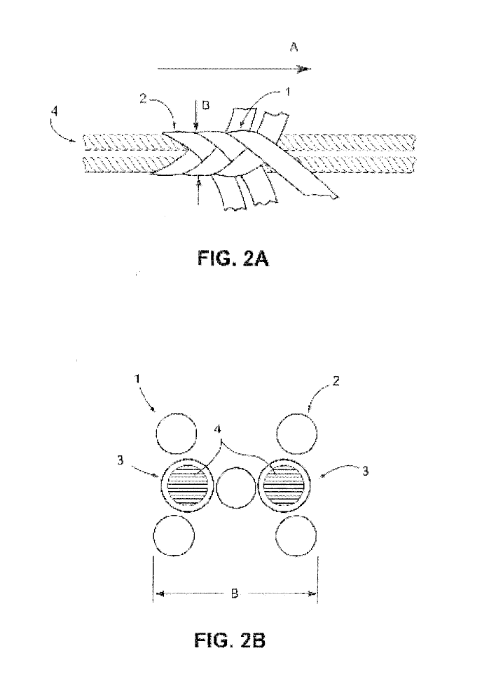

FIG. 2 shows a 5-strand rope construction of the tether of the invention;

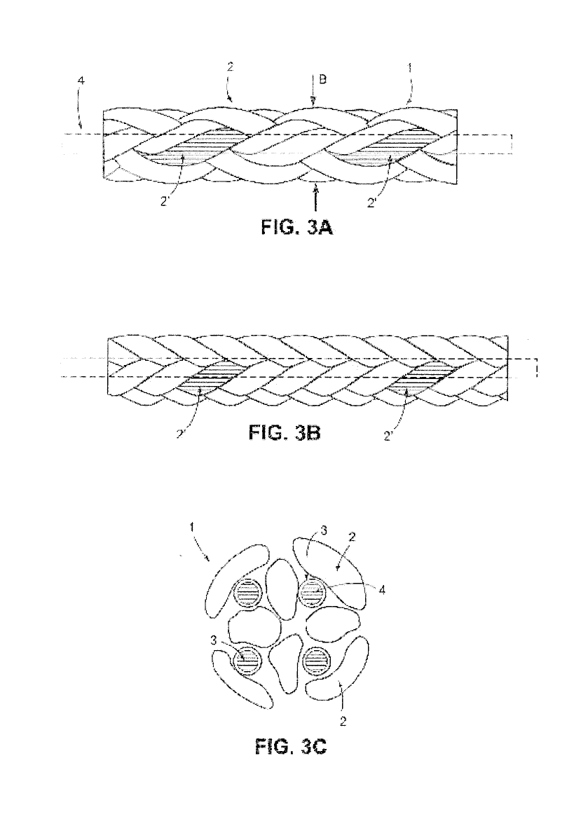

FIG. 3 shows a 8-strand rope construction of the tether of the invention;

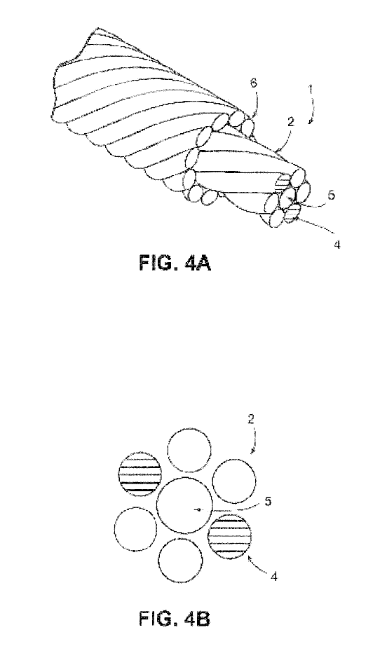

FIG. 4 shows a 6+1 (6 strands around 1 central strand) rope construction of the tether of the invention.

These figures are meant to only illustrate the invention and are not limiting the invention to the embodiments shown.

FIG. 1A (not to scale) shows schematically a tether 1 according to the invention, comprising primary strands 2. Conductors 4 are present in the longitudinal direction A. FIG. 1B shows a cross-section B of tether 1, wherein are incorporated voids 3 including conductors 4.

FIG. 2A shows a braided 5-strand rope construction of tether 1. Five strands 2 have been braided according to conventional techniques. Two conductors 4 are included in the tether. FIG. 2B shows a cross-section B of the tether of FIG. 2A, including voids 3, conductors 4 and strands 2.

FIGS. 3A and 3B show a braided 8-strand rope construction of tether 1. Strands 2 have been braided according to conventional techniques. Two conductors 4 are included in the tether. 2′ in FIGS. 3A and 3B shows one particular strand of the rope. FIG. 3C shows a cross-section B of the tether of FIG. 3A, including voids 3, conductors 4 and strands 2.

FIG. 4A shows a tether construction according to the second aspect of the invention. Tether 1 consists of a primary core strand 5, surrounded by six primary cover strands, consisting of four primary cover strands 2 containing high strength fibers and two primary cover strands 4 containing the conductor. The primary cover strands 2 are further surrounded by a second layer of cover strands 6.

The invention will be further explained with the help of the following examples without being however limited thereto.

### EXAMPLE

A tether was braided from 9 strands each containing 15 yams of 1760 dtex manufactured from UHMWPE fibers and 3 jacketed copper wires, thus in total 12 elements. The yarns were sold by DSM Dyneema®, NL, as SK75 and contained also about 20 twists per meter. The braiding period was about 64.6 mm. The 3 copper wires were separated along their entire length by the strands. The diameter of the tether was measured according to ISO 2307:2010(E). Two eye splices were introduced in the tether at both its ends to enable tensile measurements and investigate the influence of deformations on the tether. The average strength of the tether as measured on a Zwick tensile tester machine 1484-TE01 was about 38 kN. The area of the conductors was about 35%.

### Comparative Experiment

Example 1 was repeated with the difference that a number of 6 strands and 6 copper wires were used in the braid. The copper wires periodically crossed and touched each other along the braiding construction. The average strength of the tether was about 36 kN.

Test Description Before the tensile test was carried out on the Zwick machine the resistance over the copper wires was measured to ensure their continuity and capacity to carry a signal. Said resistance was determined with a Fluke 87 III device.

During the tensile test a pre-determined load was applied for a total time of 60 seconds, after which the electric resistance over the copper wires was measured again. The load was applied by mounting the eye of the splice introduced in the tether over the shackles of the Zwick machine. This process was repeated with increased tensile forces (staircase model). With this model one is able to determine the increase in resistance (i.e. loss in conductance of the copper wires). When the copper wire breaks the resistance will become infinite, in which case the Fluke device displayed an overload (OL).

The resistance was measured on 2 places in the rope, i.e. between the spliced ends (middle of the tether) and at the end of the tether (after the splice zone) where the tether went over the shackle. The most pronounced deformation of the tether took place at its ends.

The results are presented in Tables 1 and 2.

TABLE 1
Example

| | Splice | | | Between splice ends | | |
|---|---|---|---|---|---|---|
| Load: | wire 1 | wire 2 | wire 3 | wire 1 | wire 2 | wire 3 |
| 0N | 0.8 | 0.8 | 0.7 | 0.7 | 0.8 | 0.7 |
| 5000N | 0.7 | 0.75 | 0.7 | 0.7 | 0.7 | 0.7 |
| 10000N | 0.7 | 0.7 | 0.7 | 0.7 | 0.7 | 0.7 |
| 15000N | OL | OL | OL | 0.7 | 0.7 | 0.7 |
| 20000N | OL | OL | OL | 0.65 | 0.6 | 0.6 |
| 25000N | OL | OL | OL | 0.7 | 0.7 | 0.7 |
| 30000N | OL | OL | OL | 0.7 | 0.7 | 0.7 |
| 35000N | OL | OL | OL | 0.7 | OL | OL |

TABLE 2
Comparative Experiment

| | Splice | | | | | | Between splice ends | | | | | |
|---|---|---|---|---|---|---|---|---|---|---|---|---|
| Load: | wire 1 | wire 2 | wire 3 | wire 4 | wire 5 | wire 6 | wire 1 | wire 2 | wire 3 | wire 4 | wire 5 | wire 6 |
| 0N | 0.7 | 0.7 | 0.7 | 0.6 | 0.6 | 0.6 | 0.75 | 0.7 | 0.7 | 0.7 | 0.7 | 0.75 |
| 5000N | 0.8 | 0.7 | 0.6 | 0.7 | 0.7 | 0.6 | 0.7 | 0.7 | 0.7 | 0.7 | 0.7 | 0.7 |
| 10000N | OL | OL | OL | OL | OL | OL | 0.7 | 0.7 | 0.7 | 0.7 | 0.7 | 0.7 |
| 15000N | OL | OL | OL | OL | OL | OL | 0.7 | 0.6 | OL | 0.7 | 0.7 | 0.7 |
| 20000N | OL | OL | OL | OL | OL | OL | 0.6 | OL | OL | OL | OL | OL |

From the above results it can be seen that in a tether constructed in accordance with the invention the copper wire loose their capacity to transmit signals at a much larger load (30 kN) than in a tether where the copper wires cross each other (15 kN). The failure initially occurs in the eye splice. At the moment when the first copper wire failure occurred in the linear/middle part of the tether, the tether was still intact. Therefore, although still being able to anchor down a system, the tether where the copper wires cross and touch each other failed to transmit signals while a tether according to the invention was fully functional.

1. A tether containing strands comprising high strength fibers and a plurality of conductors, wherein each conductor is separated from any other conductor along its length by at least one of said strands.

2. The tether of claim 1 wherein said tether has a length direction and wherein the conductors contained by said tether have an area as measured from a cross section perpendicular to said length direction of the tether of from 15% to 75% of the total area of said cross section.

3. The tether of claim 1 wherein the tether has a length direction and wherein the tether comprises primary strands comprising high strength fibers and at least one conductor, the tether has a construction such that it comprises one or more longitudinal voids suitable for receiving the conductor, and the area of the at least one conductor in a cross section perpendicular to the length direction of the tether is 15% to 75% of the total area of said cross section.

4. The tether of claim 1 wherein the area of the at least one conductor in the cross section is 20% to 60% of the total area of the cross section.

5. The tether of claim 1 wherein the tether comprises at least two longitudinal voids each containing a conductor.

6. The tether of claim 1 wherein the tether has a diameter of at least 20 mm, preferably at least 50 mm.

7. The tether of claim 1 wherein the tether has a length of at least 100 m.

8. The tether of claim 1 wherein the conductor is aluminum or copper, preferably aluminum.

9. The tether of claim 1 wherein the conductor is aluminum or copper with a purity of at least 98 wt. % based on the total weight of the conductor.

10. The tether of claim 1 wherein the high strength fibers are fibers of ultrahigh molecular weight polyethylene (UHMWPE) having an intrinsic viscosity of at least 5 dl/g determined in decalin at 135° C.

11. The tether of claim 1 wherein the tether is a braided rope construction containing at least 5 strands, preferably primary strands, and preferably having at least two longitudinal voids.

12. The tether of claim 1 wherein the tether has 5, 8 or 12 strands, preferably primary strands.

13. The tether of claim 1 wherein at least one of the strands, preferably primary strands, comprises at least 3 laid or braided secondary strands.

14. The tether of claim 1 wherein the tether is a rope having a primary core strand containing high strength fibers, wherein the primary core is surrounded by x primary cover strands containing high strength fibers and y primary cover strands containing a conductor, wherein x and y are integers and are at least 1 and wherein x+y is at least 6.

15. The tether of claim 14 wherein the primary core strand is a laid, braided or parallel strand.

16. The tether of claim 14 wherein the primary core strand is surrounded by a cover, for example a braided or extruded cover, between the primary core strand and the primary cover strands.

17. The tether of claim 14 wherein the primary cover strands are further surrounded by a further layer of second primary cover strands.

18. Use of a tether according to claim 1, for transporting electrical power from a high altitude wind energy generator to a ground station.

19. Use of a tether according to claim 1, for transporting electrical power from a wave and tidal energy generator to a ground station.

20. Renewable energy system, comprising a renewable energy generator, a ground station for receiving energy and a tether according to claim 1, wherein the tether connects the renewable energy generator with the ground station.
